(19) United States
(12) Patent Application Publication
(10) Pub. No.: US 2025/0298990 A1
(43) Pub. Date: Sep. 25, 2025

(54) TASK PROCESSING AND EXECUTION USING LARGE LANGUAGE MODELS

(71) Applicant: Zoom Video Communications, Inc., San Jose, CA (US)

(72) Inventors: Yuanling Geng, Hangzhou (CN); Bilung Lee, Irvine, CA (US); Renjie Tao, Santa Clara, CA (US)

(73) Assignee: Zoom Video Communications, Inc., San Jose, CA (US)

(21) Appl. No.: 18/611,159

(22) Filed: Mar. 20, 2024

(51) Int. Cl. G06F 40/40

(52) U.S. Cl. CPC G06F 40/40

(57) ABSTRACT

One example method includes receiving, by an artificial intelligence (“AI”) assistant, a user query comprising one or more tasks; determining one or more services based on the user query; obtaining, for each of the one or more services, a plurality of examples, each example providing an example command suitable for execution by the respective service; generating one or more instructions based on the user query, the one or more services, and the one or more pluralities of examples; providing the one or more instructions to a trained large language model (“LLM”); receiving, from the LLM, one or more commands corresponding to the user query; for each command of the plurality of commands, issuing the respective command to a corresponding service of the one or more services; generating a response to the user query based on results of the plurality of commands; and outputting the response

### FIELD

This disclosure generally relates to large language models (“LLMs”) and more specifically relates to task processing and execution using LLMs.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-2 show example systems for task processing and execution using LLMs;

FIGS. 3A-3B show an example system for task processing and execution using LLMs;

FIG. 4 shows an example graphical user interface for task processing and execution using LLMs;

FIG. 5 shows an example method for task processing and execution using LLMs; and

FIG. 6 shows an example computing device suitable for use with example systems and methods for task processing and execution using LLMs.

### DETAILED DESCRIPTION

Examples are described herein in the context of task processing and execution using LLMs. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

During a business day or week, a person may be involved in a large number of different conversations or meetings, such as via chat channels or video conferences. However, it can be difficult to quickly access important information discussed because a recording of a video conference may be very lengthy and a chat channel may be difficult to navigate because there may be a large number of chat messages on a variety of different topics.

To help people more effectively extract relevant information from meetings they have attended or other communications that they participate in, they may use artificial intelligence (“AI”) assistants, which may employ a large language model (“LLM”) to assist with any requests. For example, a user may request that an AI assistant generate a summary of a meeting they attended or a discussion they had in a chat channel. However, for long meetings or discussions, the summary itself may be lengthy and take significant time to review in detail. In cases where a user is only interested in information about a particular topic or something that a particular person said, summarization services may not be effective. In addition, LLMs may not be able to understand context for more targeted requests about such communications.

Another difficulty with LLMs is that while they can perform generative tasks, they are not designed to execute various functionality available on a computing device. For example, if an LLM is asked to “find my pictures from my vacation to Hawaii,” the LLM may generate pictures for a Hawaiian vacation or identify web sites that have pictures of Hawaii, but it will not be able to search the user's client device to locate the pictures taken by the user because it has no information about the user's client device, what files are stored on it, or even how to search for files stored on the user's client device. Thus, to enable an AI assistant to use an LLM to process and execute tasks, helper services may be accessed to help generate the necessary context and information for a LLM to enable it to effectively perform the desired task. To do so, a user may provide a query to an AI assistant. The AI assistant receives the query and accesses a data store of available services or services that may be related to the user's query. For example, if the user's query is to “find my meeting summaries and email them to Sam,” the AI assistant determines that particular services related to searching, summarization, email generation, and calendar analysis are needed.

Once the services have been identified, a data store of examples for each of the identified services is accessed to obtain example commands for each service to help guide the AI assistant when generating the necessary outputs. For example, an example for a service may be {‘input’: “find my meetings last week’, ‘output’: ‘search (type=’meeting’, time=’last week’)’}. The example thus provides an explanation for the LLM regarding how to transform an inputted query into an executable command, such as a search command or a generate email command. In cases where multiple services are needed, each of the examples can be used by the LLM to generate a corresponding command to be executed.

After the services have been identified and the examples have been obtained, one or more prompts for the LLM may be generated based on the services and the examples. For the example query discussed above—” find my meeting summaries and email them to Sam “—a prompt may be generated that includes the user's query and that identifies the search service and its examples, the summarization service and its examples, the email generation service and its examples, and the calendar analysis service and its examples. The prompt is then provided to the LLM, which generates output that can be used to execute the necessary commands to accomplish the user's question. For example, the LLM may generate the following commands that can be sent to the appropriate application, such as a calendar application or an email application: “calendar(type=’meeting’)”, search(type=’meeting’), summarize(type=’meeting’), generate_email(to=’Sam’, title=”Meeting Summaries”, attach=’meeting summaries’). The commands may then be executed in sequence to find and summarize the meetings, generate an email and include the meeting summaries, and send the email to Sam. In this example, the AI assistant can also provide information to access the corresponding services, such as network addresses, service names, login credentials, or other related information to the LLM to enable the LLM itself to issue one or more commands to corresponding services. Otherwise, the AI assistant can obtain the commands from the LLM and use them to issue commands to the corresponding services to obtain the requested information for the user.

Using such techniques, an AI assistant can employ an LLM to determine how to identify and access services relevant to a user query and how to generate and issue commands to those services to perform whatever task(s) the user included in the submitted query. Thus, the AI assistant is able to receive a natural language query from a user and leverage an LLM's generative capabilities to employs services to provide a result based on information retrieved from various services or tasks executed by those services. Such an AI assistant can significantly improve the capabilities of the computing system to respond to user queries.

This illustrative example is given to introduce the reader to the general subject matter discussed herein and the disclosure is not limited to this example. The following sections describe various additional non-limiting examples and examples of task processing and execution using LLMs.

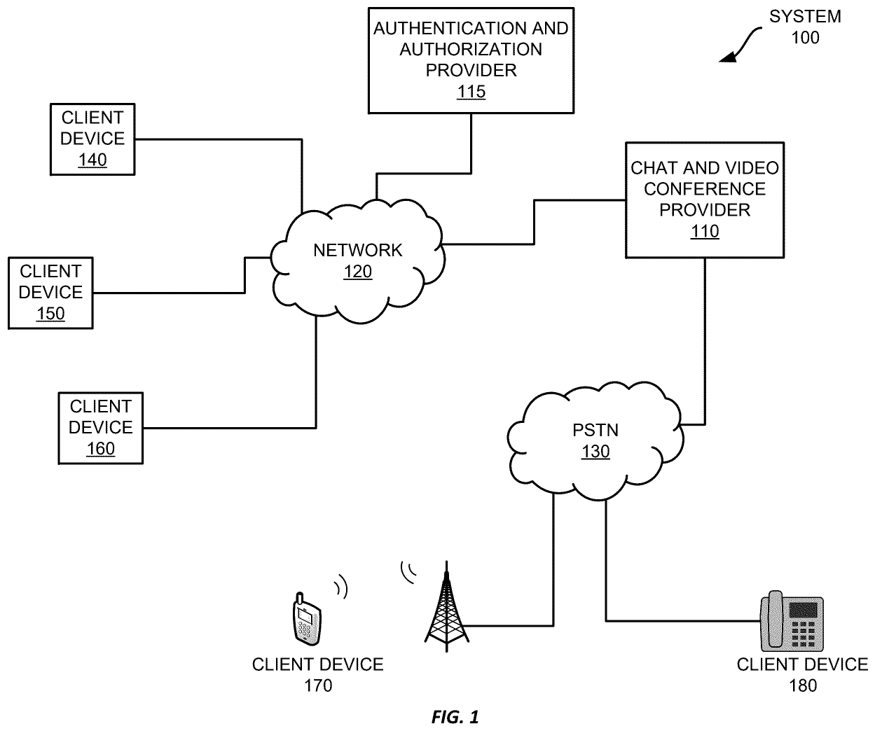

Referring now to FIG. 1, FIG. 1 shows an example system 100 that provides videoconferencing functionality to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

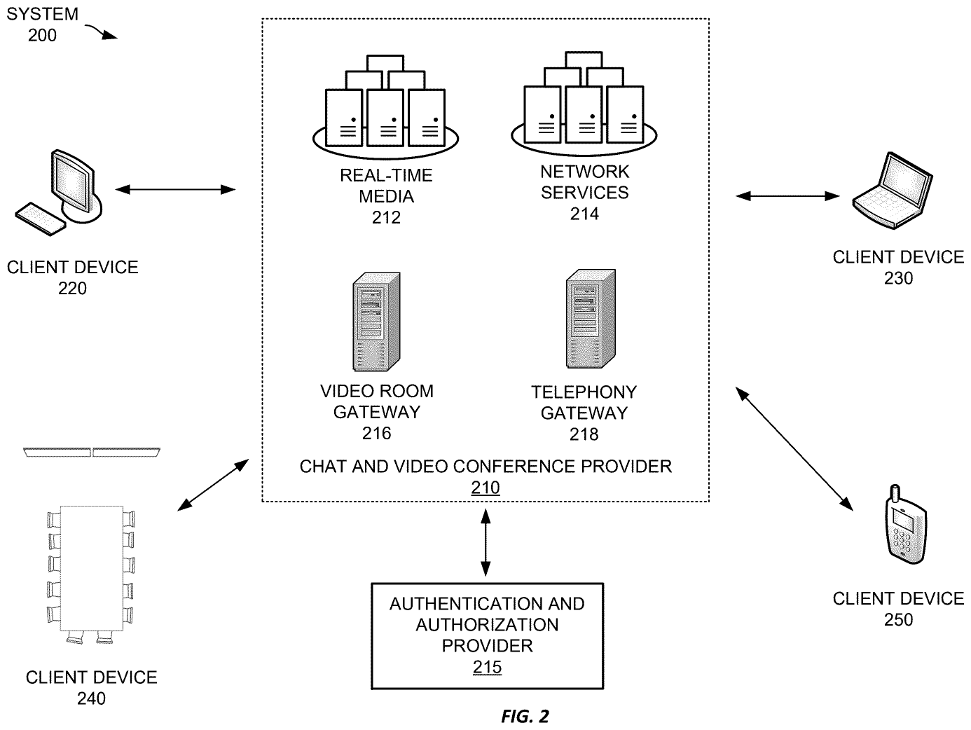

Chat and video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have associated email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a chat and video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220′s own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

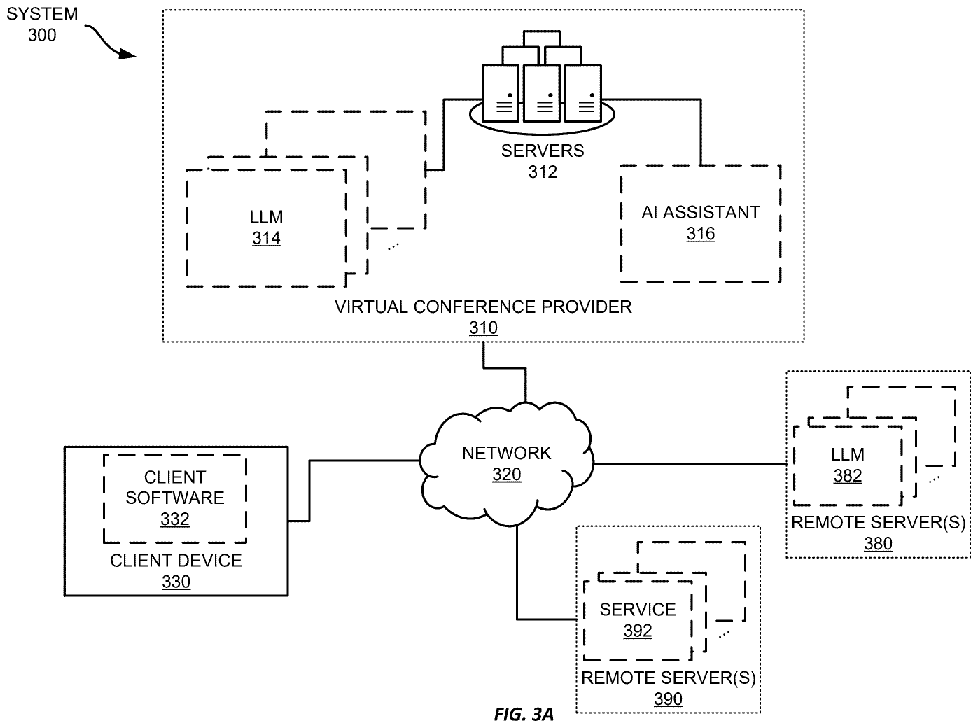

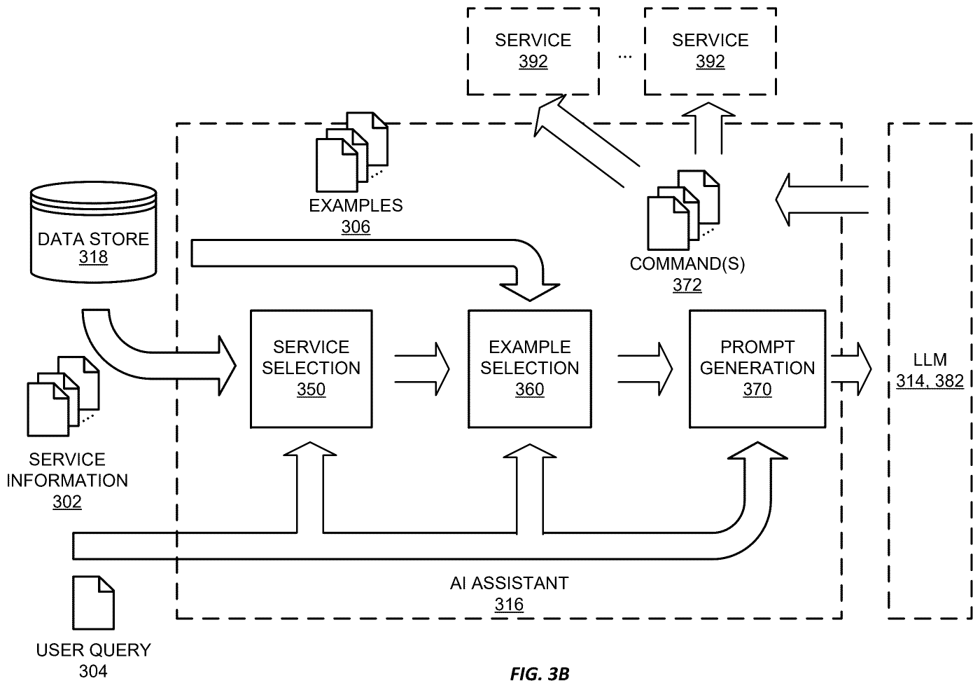

Referring now to FIGS. 3A-3B, FIG. 3A shows an example system 300 for task processing and execution using LLMs. In this example, the system 300 includes a client device 330, a virtual conference provider 310, and one or more remote servers 380 that host one or more LLMs 382. In this example, the virtual conference provider 310 provides chat and virtual conferencing capabilities, such as discussed above with respect to FIGS. 1-2, but also provides one or more servers 312 that provide one or more LLMs 314 that may be used to service requests received from users via their respective client device, such as client device 330. In addition, the virtual conference provider 310 provides an AI assistant 316 to allow users to perform task processing and execution using LLMs. And while the AI assistant 316 is shown as hosted by the virtual conference provider 310, it some examples, the client device 330 may include such an AI assistant 316, either as a stand-alone application or integrated within the client software 332. Similarly, one or more remote servers 380, 390 may host an AI assistant 316 in some examples. In some examples, the client software 332 may provide an interface to employ an AI assistant 316 hosted at the virtual conference provider 310 or one hosted at a third-party server 380, 390. In addition, the remote services 390 may provide one or more services 392 that may be employed by the AI assistant 316 to provide functionality needed to handle a user's prompt.

The LLM 314, 382 may be trained on a large corpus of data, such as information available from licensed, commercially usable, non-public datasets. For LLMs, the training data may be written materials, such as webpages, documents, emails, or blogs that may be relevant to generating written works.

Examples of LLMs include GPT models of different versions, autoregressive LLMs (e.g., Large Language Model Meta A (LLaMA)), transformer-based autoregressive LLMs (e.g., BigScience Large Open-science Open-access Multilingual Language Models (BLOOMs)), Zephyr, MISTRAL, causal decoder-only models (e.g., Falcon), or MosaicML Pretrained Transformer (MPT) models.

Client devices 330 may execute client software 332 to join and participate in virtual conferences hosted by the virtual conference provider 310. During a virtual conference, the participants can exchange audio and video streams, as discussed above with respect to FIGS. 1-2, to interact with each other, discuss any topics of interest, and share content. The virtual conference provider 310 may then generate a transcript of the virtual conference, either in real-time or based on a recording of the virtual conference. In addition, the participants can continue any discussions outside of a virtual conference, such as by using chat functionality provided by the virtual conference provider or by collaborating on one or more documents or presentations. They may also email each other using email services provided by the virtual conference provider 310 or another third party. Thus, the participants may generate one or more communication records relevant to various topics of discussion. Moreover, people may communicate about a wide variety of topics over the course of time, whether via written communication like email, chat messages, or text or short message service (“SMS”) messages, or spoken communications, such as via video conferences or telephone calls or conferences. Similarly, people may create or collaborate on documents with other people, which may include written communications, such as comments or revisions to the document. While the discussion below will be with respect to analysis of sets of communication records, it should be appreciated that it is equally applicable to analysis of a single communication record, such as a single virtual conference transcript.

To employ the AI assistant 316, a user of the client device 330 can interact with an interface, such as a chat window or other GUI window to provide one or more instructions or “prompts” to the AI assistant 316. For example, a user may instruct the AI assistant 316 to “summarize all of my communications from the last two weeks with Steve about Project Alpha.” The AI assistant 316 may then attempt to obtain the relevant communication records and generate a summary for the user. However, to accomplish such a task, the AI assistant 316 may need to identify the actions to be taken to complete the task and on what data to perform the actions. And because the identified actions may involve services provided externally to the AI assistant 316, it may need to determine how to interact with those services, e.g., services 392 hosted by third party servers 390, to obtain whatever result is appropriate. Such services may include database search functionality, email functionality, calendar functionality, LLM prompts, or any other type of service that can be used via messaging, application programming interface (“API”) calls, or otherwise have external interfaces to enable requests and responses.

To make use of such services to respond to a user's prompt, the AI assistant 316 analyzes the incoming prompt to identify services that may be needed to handle the prompt. It can then then obtain example commands for those identified services, such as example search commands for an email inbox or a database. The AI assistant 316 can then use the user query, the identified services, and the identified examples for those services to generate one or more instructions for an LLM to create appropriate commands to issue to the various services, as well as the order in which to issue those commands, to handle the prompt provided by the user. The AI assistant 316 can then access the identified services and provide the LLM-generated commands to those services to obtain suitable results. After processing all of the commands, the final results can be provided to the user, such as via a GUI, a chat message, an email, a document, or any other suitable format.

Referring now to FIG. 3B, FIG. 3B shows the AI assistant 316 of the system 300 shown in FIG. 3A. As discussed above, the AI assistant 316 may be executed by the client device 330, the virtual conference provider 310, or by any third-party computing device, such as any of the depicted servers 380, 390.

The AI assistant 316 employs service selection functionality 350, example selection functionality 360, and prompt generation functionality 370 to generate suitable prompts to an LLM 314, 382 to generate one or more commands that can be used to perform the task(s) requested within the user's query 304.

When a user submits a user query 304 to the AI assistant 316, such as “please summarize my discussions with Bob Smith over the last two weeks,” the AI assistant 316 first determines which services 392 may be needed to perform some or all of the requested task(s). In this case, while the user query 304 includes one over-arching task of obtaining a summary, it includes several implicit tasks as well: searching the user's communication records for communications and filtering those communications based on the participants and the timing of the communications. Thus, the AI assistant 316 needs to analyze the user query 304 to identify any such services that may be needed.

To do so, in this example, the AI assistant 316 employs the service selection functionality 350. The service selection functionality 350 is provided the user query 304 and also accesses data store 318, which stores information 302 about the services that are supported by the AI assistant 316. The data store 318 may be hosted by the virtual conference provider 310 or any other remote server. Moreover, multiple data stores may be accessed to obtain information about available services. The service information 302 includes descriptions of the functionality provided by the services and may also include other information such as the names of the services. The service selection functionality 350 determines similarities between the user query 304 and the available services based on the service information 302.

In this example, the service selection functionality 350 employs a trained ML model, such as a trained autoencoder, a trained predictor model, or any other variety of trained neural network, to generate binary embeddings for the user query 306 and for at least a portion of the service information 302, such as the service descriptions. The binary embeddings may be generated based on the entirety of the user query 304 or service information 302, or multiple embeddings may be generated for each based on individual words, phrases, sentences, or other portions of the user query or service information 302. The binary embeddings are then used to select one or more relevant services 392. In this example, the service selection functionality 350 analyzes each service description embedding against the user query embedding to determine a similarity score for the embeddings. If the similarity score satisfies a predetermined threshold, the service is determined to be related to the user query. Otherwise, the service is determined to be not related to the user query. Through this process, relevant services 392 are selected.

While the example shown in FIG. 3B employs binary embeddings, other techniques may be used to determine relationships between the user query 304 and one or more services 392. For example, rather than generating binary embeddings using a trained ML model 345, as discussed above, a cross-encoder may be provided with textual inputs representing the user query 304 and service information 302. The cross-encoder compares the two textual inputs to determine a similarity between them and outputs a score or confidence indicating the level of similarity, e.g., a value between 0 and 1. Thus, the service selection functionality 350 could employ such a technique to identify services that are sufficiently related to the user query, e.g., the score satisfies a threshold such as 80% or 90%. After analyzing each service description with respect to the user query 304, a set of related segments can be generated. And while these techniques represent some ways to determine relevancy for segments, others may be used. For example, the segment selection functionality 350 may employ an LLM to determine the relevance of one or more services 392 to the user query 304.

After the service selection functionality 350 identifies one or more relevant services 392 for the user query 304, it then identifies one or more examples for each identified service. The examples 306 provide example commands that could be submitted to a service for a task to be performed for a corresponding example user query. For example, an example for a search service may be “{‘input’: ‘find my chats’, ‘output’: ’search(type=‘chat’)’}” or {‘input’: ‘summarize my chats and meeting with Sam, ‘output’: ‘search(type=[‘chat’, ‘meeting’], person=‘Sam’)’}.” Thus, the examples provide a mapping from an example user query to an example command usable with a service 392.

In this example system, the AI assistant 316 selects a number of examples that corresponds to the relevancy of a selected service 392 to the user query 304 and based on the user query. As discussed above with respect to the service selection functionality 350, the AI assistant 316 determines a relevancy of one or more services 392 to the user query 304. The relevancy may be a value between 0 and 1 or on any other scale. For services that are highly relevant to the user query, e.g., they have a relevancy of 0.9 or 0.95 or greater, the example selection functionality 360 may select a maximum number of examples, such as twenty examples. For services with a lesser relevancy, e.g., a relevancy of 0.7 to 0.9, a smaller number of examples 306 may be selected, e.g., fifteen examples. For even less relevant services, an even smaller number of examples 306 may be obtained, e.g., five to seven examples. The example selection is able to ensure that the most relevant services have a large number of examples to enable the LLM 314, 382 to ultimately generate a command for the particular service. And while this example system selects a number of examples 306 for a selected service based on the service's relevance to the user query 304, in some examples, a fixed number of examples may be provided for all selected services.

Further, the example selection functionality 360 determines relevant examples based on a comparison of the available examples to the user query. In this example, the example selection functionality 360 generates embeddings for the examples and for the user query 304 (or re-uses the previously generated embedding for the user query 304), which may be used to determining a score or confidence indicating a relevancy of the example to the user query 304, as discussed above. Though other examples may employ techniques discussed above with respect to the service selection functionality 350, such as by using a cross-encoder to determine a score or confidence of a relevancy of the example to the user query 304. Thus, the example selection functionality 360 is able to select examples that are both relevant to the service and to the particular user query 304.

After the AI assistant 316 has obtained relevant examples 306 for each of the identified services, the AI assistant 316 employs prompt generation functionality 370 to generate one or more instructions or prompts for the LLM 314, 382 to generate suitable commands 372 that can be issued to the identified services. In this example, the prompt generation functionality 370 generates a prompt from a pre-defined template, such as “Please generate commands for the following services: [identified service], . . . [identified service] to perform the user's requested task: [user query]. Use these examples as the basis to generate the commands for the identified services: [examples].” Additional instructions may be included, such as “Provide the commands in the order in which they should be executed based on the user's query.” In some examples, the prompt generation functionality 370 may request that all of the commands be returned at once, or it may request that the LLM 314, 382 provide the commands one at a time in response to subsequent requests for additional commands. Still other techniques may be employed.

The commands 372 generated by the LLM 314, 382 include the information to be provided to a particular service or used to invoke particular functionality from a service, such as a properly formatted SQL database query or a properly formatted XML query for a web service. The commands may also include other information needed to employ the services, such as network addresses or usernames and passwords (or other access credentials).

After the AI assistant 316 receives the commands 372, it communicates with the relevant services in the order specified by the LLM 314, 382 and issues the commands to the services to obtain the desired result. For example, a first command may be to search for all communication records with Bob Smith in the last two weeks, which results in a number of communication records being returned. The next command may be a command to a summarization service to summarize the received communication records. Once the last command is issued, the results of the processing may then be provided to the user. For example, the summary of the communication records may be provided to the user, such as in a GUI or via another communication channel, such as a chat channel or an email.

And while in this example, the AI assistant 316 provides the instructions to the services 392, in some examples, the AI assistant 316 may instruct the LLM itself to communicate with one or more of the services to generate a corresponding result. For example, the prompt generation functionality 370 may generate an instruction for each received command 372 to issue the command directly from the LLM 314, 382. The prompt generation functionality 372 may further generate the instruction to the LLM 314, 382 to output the result of the command. The AI assistant 316 may then either instruct the LLM 314, 382 to perform the next command based on the result or the AI assistant 316 itself may issue the next command based on the result. In some examples, the AI assistant 316 may maintain an identification of which services may be invoked by the LLM 314, 382 and which may be invoked by the AI assistant 316. Thus, the prompt generation functionality 370 may generate prompts to instruct the LLM 314, 382 to issue one or more commands to a particular service or services based on the identifications of services to be invoked by the LLM 314, 382.

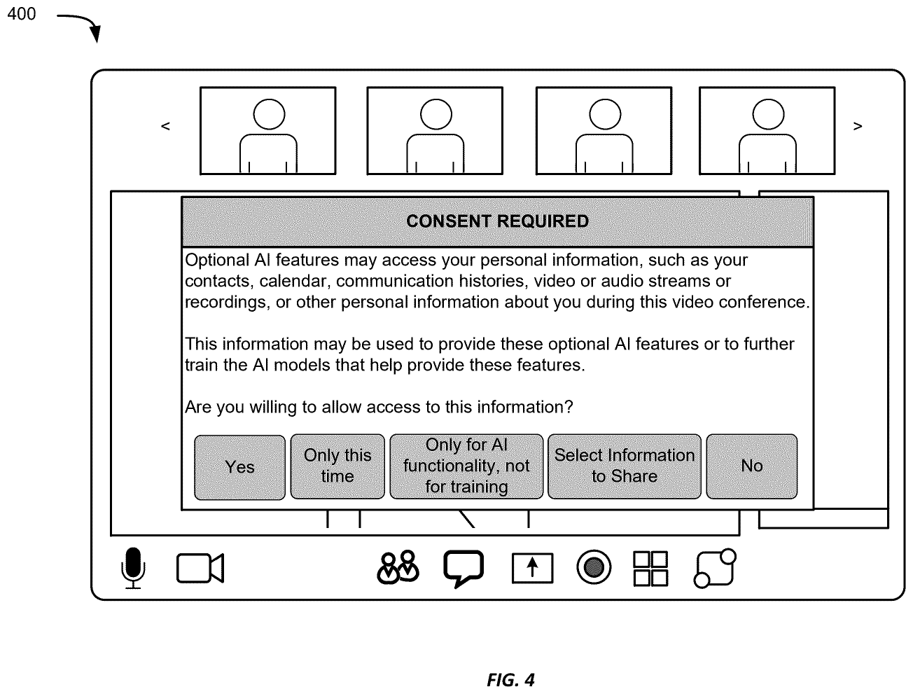

Referring to FIG. 4, FIG. 4 shows a GUI 400 presenting a consent option to employ certain AI-assisted features. In some examples according to the present disclosure, a user may select an option to use one or more optional AI features available from the virtual conference provider, such as the task processing and executing using LLMs as described herein. The use of these optional AI features may involve providing the user's personal information to the AI models underlying the AI features. The personal information may include the user's contacts, calendar, communication histories, video or audio streams, recordings of the video or audio streams, transcripts of audio or video conferences, or any other personal information available to the virtual conference provider. Further, the audio or video feeds may include the user's speech, which includes the user's speaking patterns, cadence, diction, timbre, and pitch; the user's appearance and likeness, which may include facial movements, eye movements, arm or hand movements, and body movements, all of which may be employed to provide the optional AI features or to train the underlying AI models.

Before capturing and using any such information, whether to provide optional AI features or to providing training data for the underlying AI models, the user may be provided with an option to consent, or deny consent, to access and use some or all of the user's personal information. In general, Zoom's goal is to invest in AI-driven innovation that enhances user experience and productivity while prioritizing trust, safety, and privacy. Without the user's explicit, informed consent, the user's personal information will not be used with any AI functionality or as training data for any AI model. Additionally, these optional AI features are turned off by default—account owners and administrators control whether to enable these AI features for their accounts, and if enabled, individual users may determine whether to provide consent to use their personal information.

As can be seen in FIG. 4, a user has engaged in a video conference and has selected an option to use an available optional AI feature. In response, the GUI has displayed a consent authorization window for the user to interact with. The consent authorization window informs the user that their request may involve the optional AI feature accessing multiple different types of information, which may be personal to the user. The user can then decide whether to grant permission or not to the optional AI feature generally, or only in a limited capacity. For example, the user may select an option to only allow the AI functionality to use the personal information to provide the AI functionality, but not for training of the underlying AI models. In addition, the user is presented with the option to select which types of information may be shared and for what purpose, such as to provide the AI functionality or to allow use for training underlying AI models.

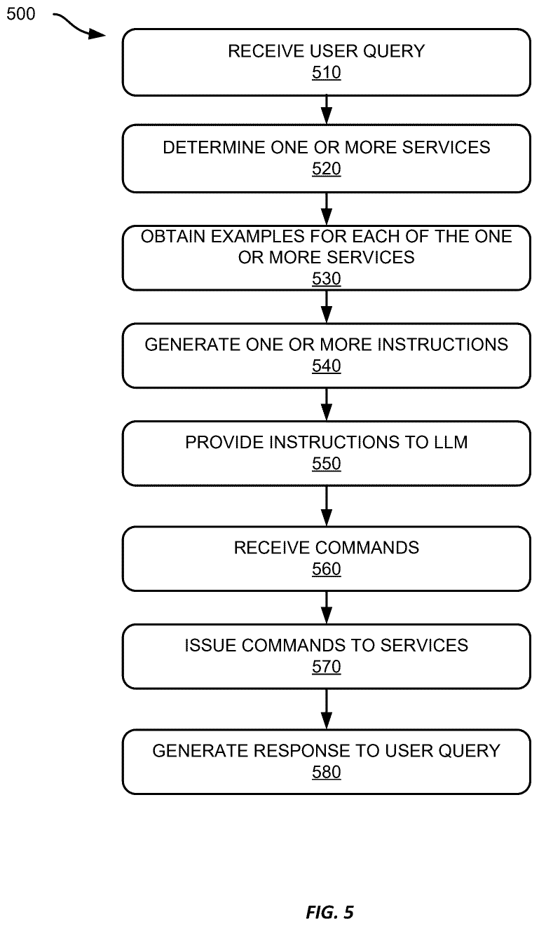

Referring now to FIG. 5, FIG. 5 shows an example method 500 for task processing and execution using LLMs. The method 500 will be described with respect to the system 300 shown in FIGS. 3A-3B; however, it should be appreciated than any suitable system or GUI window according to this disclosure may be employed for example methods according to this disclosure. Moreover, while the discussion above and herein is in the context of a virtual conference provider, it should be appreciated that any service provider may be employed, or the functionality may be performed by a user's own client device.

At block 510, the AI assistant 316 receives a user query 304 comprising one or more tasks. As discussed above with respect to FIG. 3B, a task may have one or more explicit tasks as well as one or more implicit tasks, which may be tasks that are not specifically identified in the query, but that are needed to perform the query, such as performing search functionality.

At block 520, the AI assistant 316 determines one or more services based on the user query 304, generally as discussed above with respect to FIG. 3A. In this example, the service selection functionality 350 generates one or more embeddings based on the user query 304 and one or more embeddings based on the service information 302. It then determines similarities between the one or more embeddings for the user query 304 and the one or more embeddings for the service information 302 to obtain a score or confidence that a particular service is relevant to the user query 304. Based on the scores or confidences for each service, the service selection functionality 350 selects one or more of the services. For example, the service selection functionality 350 may select any services that have a score or confidence that satisfied a predetermined threshold. In some examples, the service selection may select the top five (or other number) services based on their scores or confidences.

At block 530, the AI assistant 316 obtains a plurality of examples, generally as discussed above with respect to FIG. 3B. In this example, the AI assistant 316 obtains examples for each of the services identified at block 520, with each example provide an example command suitable for execution by the respective service. As discussed above, the examples may be obtained based upon determined similarities between the example and the user query, such as by generating embeddings for the examples and the user query.

At block 540, the AI assistant 316 generates one or more instructions based on the user query, the one or more services identified at block 520, and the obtained examples, generally as discussed above with respect to FIG. 3B. In this example, the AI assistant 316 employs the prompt generation functionality 370 to generate one or more instructions to be provided to the LLM 314, 382 to generate suitable commands 372 to be provided to the one or more services 392.

At block 550, the AI assistant 316 provides the one or more instructions to the LLM 314, 382, generally as discussed above with respect to FIG. 3B.

At block 560, the AI assistant 316 receives one or more commands from the LLM based on the instructions, generally as discussed above with respect to FIG. 3B.

At block 570, the AI assistant 316 issues one or more commands to the identified services, generally as discussed above with respect to FIG. 3B. In this example, the AI assistant 316 communicates with the identified services 392 and issues commands 372 accordingly. However, in some examples, the LLM 314, 382 may issue commands 372 to services 392, or a combination of the AI assistant 316 and the LLM 314, 382 may issue the commands to the services 392.

At block 580, the AI assistant 316 generates and outputs a response to the user query based on the results of the commands issued to the services 392, generally as described above.

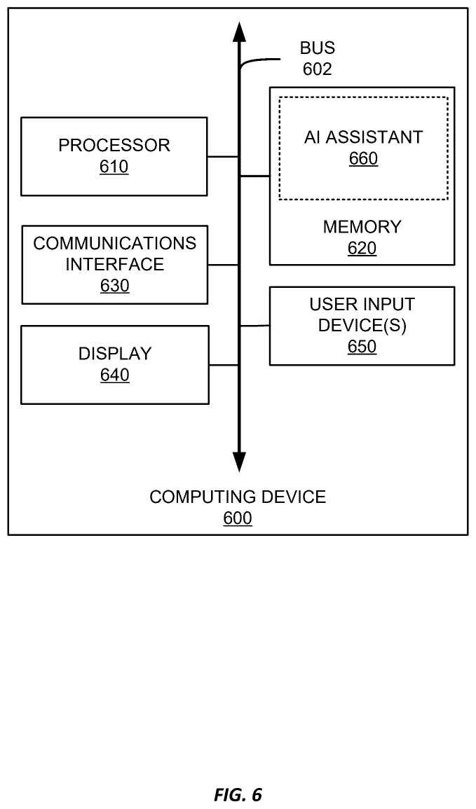

Referring now to FIG. 6, FIG. 6 shows an example computing device 600 suitable for use in example systems or methods for task processing and execution using LLMs according to this disclosure. The example computing device 600 includes a processor 610 which is in communication with the memory 620 and other components of the computing device 600 using one or more communications buses 602. The processor 610 is configured to execute processor-executable instructions stored in the memory 620 to perform one or more methods for task processing and execution using LLMs according to different examples, such as part or all of the example method 500 described above with respect to FIG. 5. Suitable example computing devices 600, such as user client devices, may also include one or more user input devices 650, such as a keyboard, mouse, touchscreen, microphone, etc., to accept user input. The computing device 600 also includes a display 640 to provide visual output to a user. In addition, the computing device 600 includes an AI assistant 660, such as discussed above with respect to FIGS. 3A-3B.

The computing device 600 also includes a communications interface 630. In some examples, the communications interface 630 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
receiving, by an artificial intelligence (“AI”) assistant, a user query comprising one or more tasks;
determining one or more services based on the user query;
obtaining, for each of the one or more services, a plurality of examples, each example providing an example command suitable for execution by the respective service;
generating one or more instructions based on the user query, the one or more services, and the one or more pluralities of examples;
providing the one or more instructions to a trained large language model (“LLM”);
receiving, from the LLM, one or more commands corresponding to the user query;
for each command of the one or more commands, issuing the respective command to a corresponding service of the one or more services;
generating a response to the user query based on results of the one or more commands; and
outputting the response.

2. The method of claim 1, further comprising:
generating, using a trained ML model, one or more first embeddings based on the user query;
generating, using the trained ML model, one or more second embeddings based on descriptions of the one or more services; and
wherein determining the one or more services is based on the one or more first embeddings and the one or more second embeddings.

3. The method of claim 2, further comprising:
determining, for each service, a confidence based on the one or more first embeddings and one or more second embeddings corresponding to the respective service; and
determining the one or more services based on the respective confidences and a confidence threshold.

4. The method of claim 2, further comprising:
determining, for each service, a confidence based on the one or more first embeddings and one or more second embeddings corresponding to the respective service; and
wherein obtaining, for each of the one or more services, the plurality of examples is based on the respective confidence for the respective service.

5. The method of claim 1, further comprising:
for each example, generating a relevancy based on the user query; and
wherein obtaining, for each of the one or more services, the plurality of examples is based on the respective relevancies.

6. The method of claim 5, further comprising:
generating, using a trained ML model, one or more first embeddings based on the user query;
generating, using the trained ML model, one or more second embeddings based on the pluralities of examples; and
wherein generating the relevancy is based on at least a subset of the one or more first embeddings and the respective one or more second embeddings associated with the respective example.

7. The method of claim 1, wherein the issuing the respective command is performed by the AI assistant.

8. The method of claim 1, wherein the issuing the respective command is performed by the trained LLM.

9. A system comprising:
a non-transitory computer-readable medium; and
one or more processors communicatively connected to the non-transitory computer-readable medium, the one or more processors configured to execute processor-executable instructions stored in the non-transitory computer-readable medium to cause the one or more processors to:
receive, by an artificial intelligence (“AI”) assistant, a user query comprising one or more tasks;
determine one or more services based on the user query;
obtain, for each of the one or more services, a plurality of examples, each example providing an example command suitable for execution by the respective service;
generate one or more instructions based on the user query, the one or more services, and the one or more pluralities of examples;
provide the one or more instructions to a trained large language model (“LLM”);
receive, from the LLM, one or more commands corresponding to the user query;
for each command of the one or more commands, issue the respective command to a corresponding service of the one or more services;
generate a response to the user query based on results of the one or more commands; and
output the response.

10. The system of claim 9, wherein the one or more processors are configured to execute further processor-executable instructions stored in the non-transitory computer-readable medium to:
generate, using a trained ML model, one or more first embeddings based on the user query;
generate, using the trained ML model, one or more second embeddings based on descriptions of the one or more services; and
wherein determining the one or more services is based on the one or more first embeddings and the one or more second embeddings.

11. The system of claim 10, wherein the one or more processors are configured to execute further processor-executable instructions stored in the non-transitory computer-readable medium to:
determine, for each service, a confidence based on the one or more first embeddings and one or more second embeddings corresponding to the respective service; and
determine the one or more services based on the respective confidences and a confidence threshold.

12. The system of claim 10, wherein the one or more processors are configured to execute further processor-executable instructions stored in the non-transitory computer-readable medium to:
determine, for each service, a confidence based on the one or more first embeddings and one or more second embeddings corresponding to the respective service; and
wherein obtaining, for each of the one or more services, the plurality of examples is based on the respective confidence for the respective service.

13. The system of claim 9, wherein the one or more processors are configured to execute further processor-executable instructions stored in the non-transitory computer-readable medium to:
for each example, generate a relevancy based on the user query; and
wherein obtaining, for each of the one or more services, the plurality of examples is based on the respective relevancies.

14. The system of claim 13, wherein the one or more processors are configured to execute further processor-executable instructions stored in the non-transitory computer-readable medium to:
generate, using a trained ML model, one or more first embeddings based on the user query;
generate, using the trained ML model, one or more second embeddings based on the pluralities of examples; and
wherein generating the relevancy is based on at least a subset of the one or more first embeddings and the respective one or more second embeddings associated with the respective example.

15. The system of claim 9, wherein the issuing the respective command is performed by the AI assistant.

16. The system of claim 9, wherein the issuing the respective command is performed by the trained LLM.

17. A non-transitory computer-readable medium comprising processor-executable instructions configured to cause one or more processors to:
receive, by an artificial intelligence (“AI”) assistant, a user query comprising one or more tasks;
determine one or more services based on the user query;
obtain, for each of the one or more services, a plurality of examples, each example providing an example command suitable for execution by the respective service;
generate one or more instructions based on the user query, the one or more services, and the one or more pluralities of examples;
provide the one or more instructions to a trained large language model (“LLM”);
receive, from the LLM, one or more commands corresponding to the user query;
for each command of the one or more commands, issue the respective command to a corresponding service of the one or more services;
generate a response to the user query based on results of the one or more commands; and
output the response.

18. The non-transitory computer-readable medium of claim 17, wherein the one or more processors are configured to execute further processor-executable instructions stored in the non-transitory computer-readable medium to:
generate, using a trained ML model, one or more first embeddings based on the user query;
generate, using the trained ML model, one or more second embeddings based on descriptions of the one or more services; and
wherein determining the one or more services is based on the one or more first embeddings and the one or more second embeddings.

19. The non-transitory computer-readable medium of claim 18, wherein the one or more processors are configured to execute further processor-executable instructions stored in the non-transitory computer-readable medium to:
determine, for each service, a confidence based on the one or more first embeddings and one or more second embeddings corresponding to the respective service; and
determine the one or more services based on the respective confidences and a confidence threshold.

20. The non-transitory computer-readable medium of claim 17, wherein the one or more processors are configured to execute further processor-executable instructions stored in the non-transitory computer-readable medium to:
for each example, generate a relevancy based on the user query; and
wherein obtaining, for each of the one or more services, the plurality of examples is based on the respective relevancies.
